(19) United States
(12) Patent Application Publication
(10) Pub. No.: US 2010/0115818 A1
(43) Pub. Date: May 13, 2010

(54) DECOY TECHNOLOGY

(76) Inventor: Jay Rogers, Hudson, WI (US)

Correspondence Address: JOEL D. SKINNER, JR.;SKINNER AND ASSOCIATES, 212 COMMERCIAL ST., HUDSON, WI, 54016, US

(21) Appl. No.: 12/617,378

(22) Filed: Nov. 12, 2009

Related U.S. Application Data
(60) Provisional application No. 61/113,415, filed on Nov. 11, 2008.

(51) Int. Cl. A01M 31/06

(52) U.S. Cl. 43/2

(57) ABSTRACT

A wild turkey decoy for use in wild turkey hunting to attract wild turkeys. The decoy includes both static and dynamic decoy features. The decoy has a decoy body, an actuatable fan assembly connected to the decoy body, and a support assembly connected to the decoy body. A preferred decoy apparatus includes (a) a decoy body, (b) a fan assembly attached to the decoy body, the fan assembly including a longitudinally pivotable bracket and a laterally pivotable fan attached to the bracket, wherein the bracket includes a base, a tail pivotally connected to the base, and a spring connected to the base and the tail that biases the tail with respect to the base, and wherein the fan includes a hub, a plurality of elongated struts pivotally connected to the hub, a flexible decoy member connected to at least one strut, and at least one spring connected to the hub and at least one strut that biases at least one strut with respect to the remaining struts; (c) an actuator to actuate the fan assembly so that the bracket longitudinally pivots and the fan laterally pivots, wherein the means to actuate includes at least one line communicatively connected to the bracket and connected to the fan, the line extending away from the body and being adapted to be pulled by a user of the decoy apparatus to longitudinally pivot the bracket and laterally pivot the fan; and (d) a support assembly connected to the body for securing the body to the environment

### CROSS-REFERENCE TO RELATED APPLICATIONS, IF ANY

This application claims the benefit under 35 U.S.C. §119(e) of co-pending U.S. Provisional Patent Application Ser. No. 61/113,415, filed Nov. 11, 2008, which is hereby incorporated by reference.

### 37 C.F.R. §1.71(e) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

The present invention relates, generally, to hunting systems, apparatus and methods. Particularly, the invention relates to hunting decoy systems, apparatus and methods. Most particularly, the invention relates to turkey hunting decoy systems, apparatus and methods.

2. Background Information

Existing technology in this field is believed to have significant limitations and shortcomings. For this and other reasons, a need exists for the present invention.

All US patents and patent applications, and all other published documents mentioned anywhere in this application are incorporated by reference in their entirety.

### BRIEF SUMMARY OF THE INVENTION

The invention provides an turkey hunting decoy system, apparatus and method which are practical, reliable, effective and efficient, and which are believed to fulfill the need and to constitute an improvement over the background technology.

In one aspect, the invention provides a wild turkey decoy for use in wild turkey hunting to attract wild turkeys. The decoy includes both static and dynamic decoy features. The decoy has a decoy body, an actuatable fan assembly removably connectable to the decoy body, and a support assembly connected to the decoy body.

In another aspect, the invention provides decoy apparatus comprising a decoy body, a fan assembly attached to the decoy body, the fan assembly including a longitudinally pivotable bracket and a laterally pivotable fan attached to the bracket; and means to actuate the fan assembly so that the bracket longitudinally pivots and the fan laterally pivots.

In a further aspect, the invention provides portable, wild turkey decoy apparatus, comprising:
a. a decoy body;
b. a fan assembly attached to the decoy body, the fan assembly including a longitudinally pivotable bracket and a laterally pivotable fan attached to the bracket, wherein the bracket includes a base, a tail pivotally connected to the base, and a spring connected to the base and the tail that biases the tail with respect to the base, the spring normally biasing the tail away from the base, and wherein the fan includes a hub, a plurality of elongated struts pivotally connected to the hub, a flexible bag-style decoy member covering the struts and connected to at least one strut, and at least one spring connected to the hub and at least one strut that biases at least one strut with respect to the remaining struts, the spring normally biasing the struts away from one another;
c. at least one line communicatively connected to the bracket and connected to the fan, the line actuating the fan assembly so that the bracket longitudinally pivots and the fan laterally pivots, the line extending away from the body and being adapted to be pulled by a user of the decoy apparatus to longitudinally pivot the bracket and laterally pivot the fan; and
d. a support assembly connected to the body for securing the body to the environment

And in yet another aspect, the invention provides a realistic, collapsible full-body, full strut, jake decoy with a removable fan. It includes a string-activated mechanical tail that changes from the full strut open position to a fully closed down position by simply pulling the string. In use, the jake body and tail provoke aggressive mature tom turkeys to come in and challenge the decoy, providing the user with an optimum shot with either a firearm or bow and arrow. The string, preferably 100 feet or more, is managed via line caddy. The decoy system may be contained in a mesh carry bag preferably with orange safety accents, for transportation, deployment and take down, and off season storage. The decoy system includes a 2-piece stake and the mechanical jake tail is removable.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 is a perspective view of an embodiment of the decoy of the present invention.

FIG. 2 is another perspective view of the decoy.

FIG. 3 is an exploded view of the decoy.

FIG. 4 is a side, elevation view of the decoy, the opposite side being substantially similar thereto.

FIG. 5 is a front end view of the decoy.

FIG. 6 is a back end view of the decoy.

FIG. 7 is a top view of the decoy.

FIG. 8 is a bottom view of the decoy.

FIG. 9 is a view of the decoy showing a fan in an initial state.

FIG. 10 is a view of the decoy showing the fan in a partially actuated, intermediate state.

FIG. 11 is a view of the decoy showing the fan in a fully actuated, end state.

FIG. 12 is an exploded view of an embodiment of the bracket of the fan assembly of the decoy.

FIG. 13 is an exploded view of an embodiment of a fan of the fan assembly.

FIG. 14 is an exploded view of an embodiment of a support assembly of the decoy.

### DETAILED DESCRIPTION

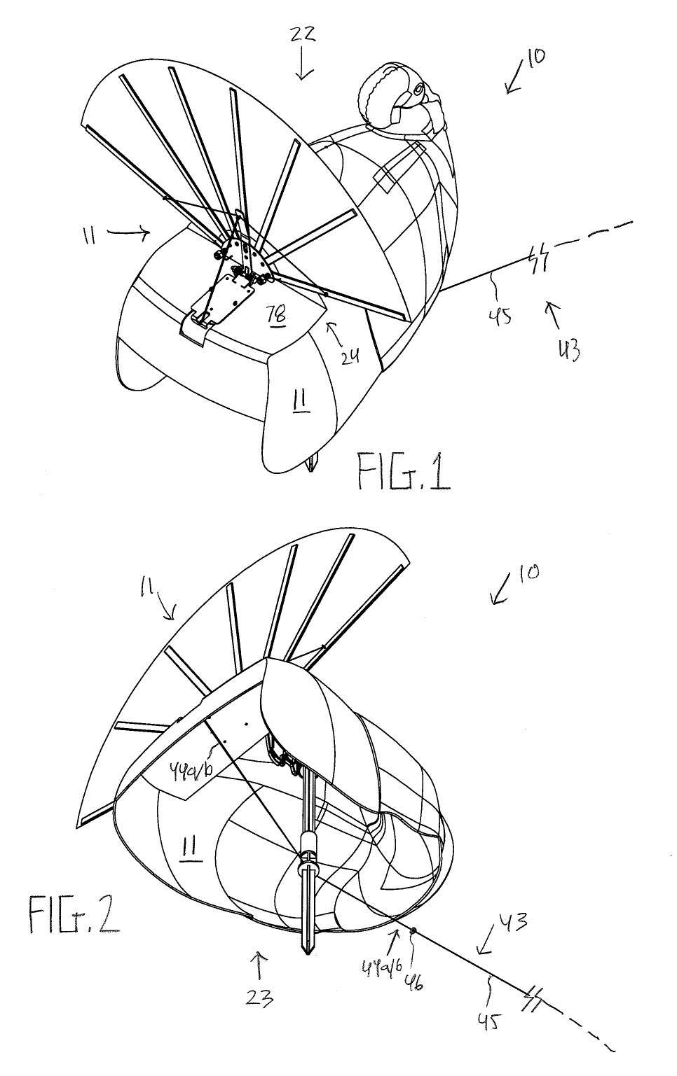

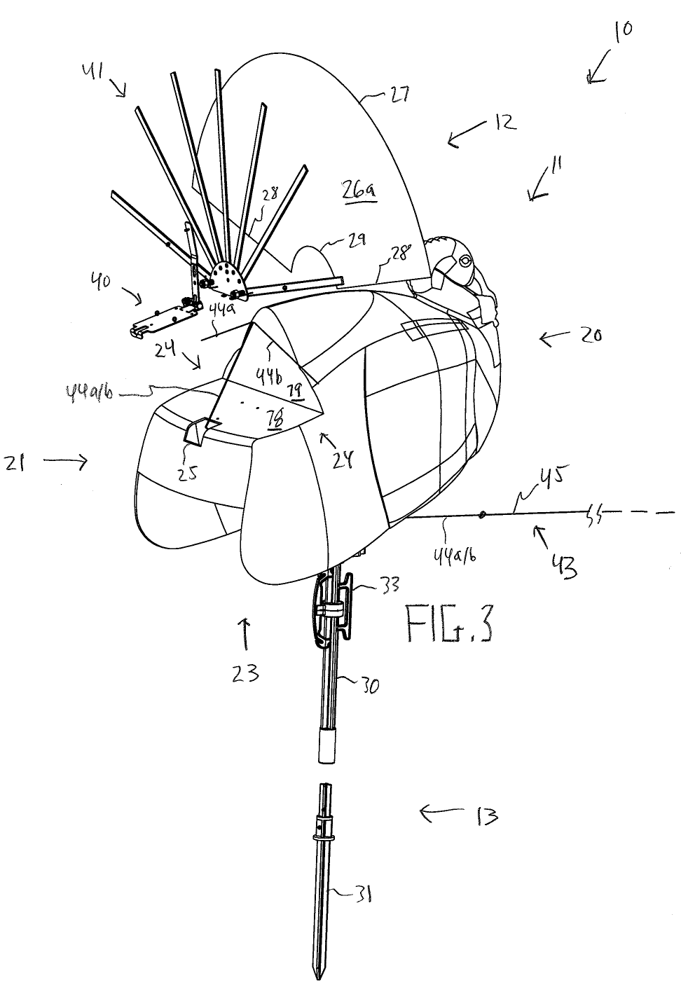

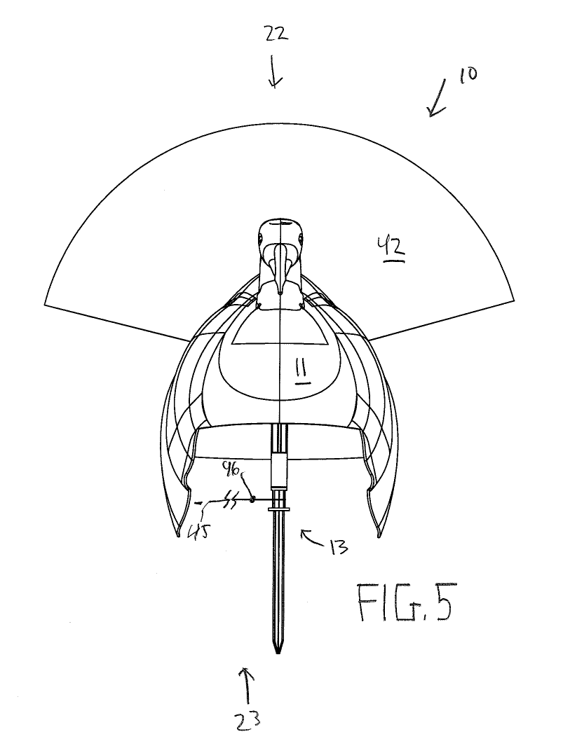

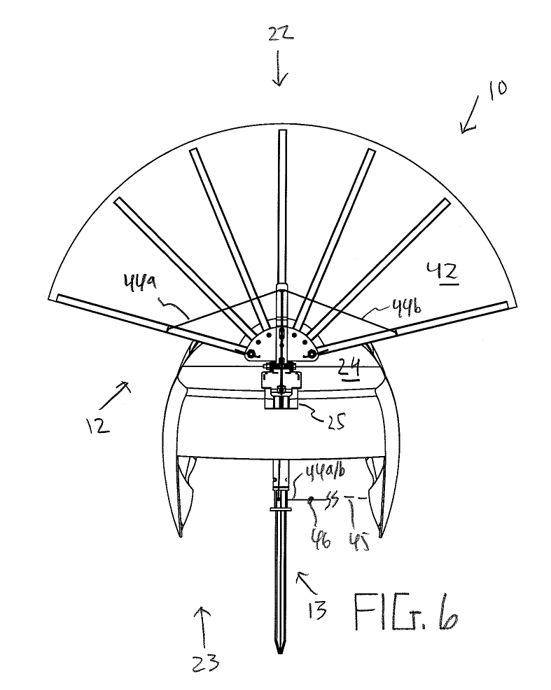

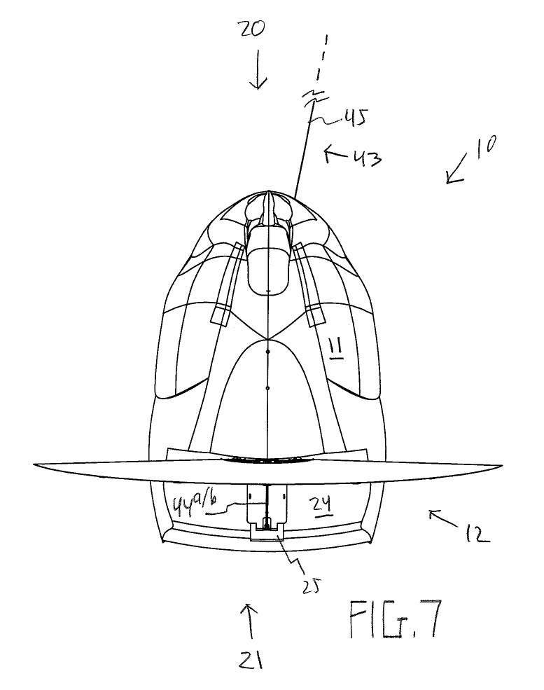

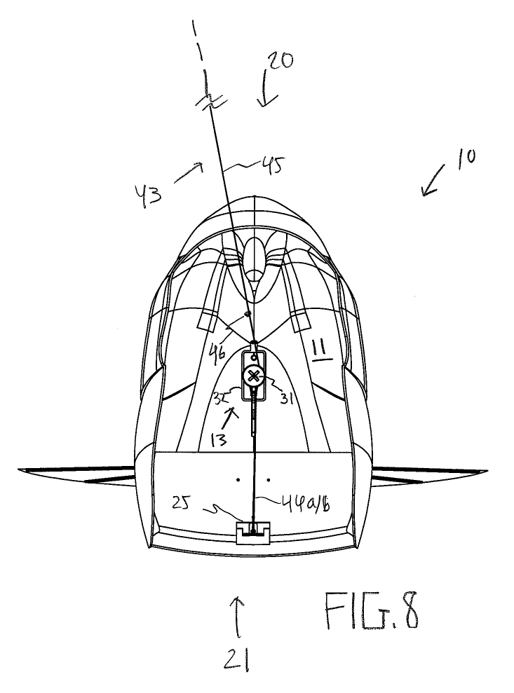

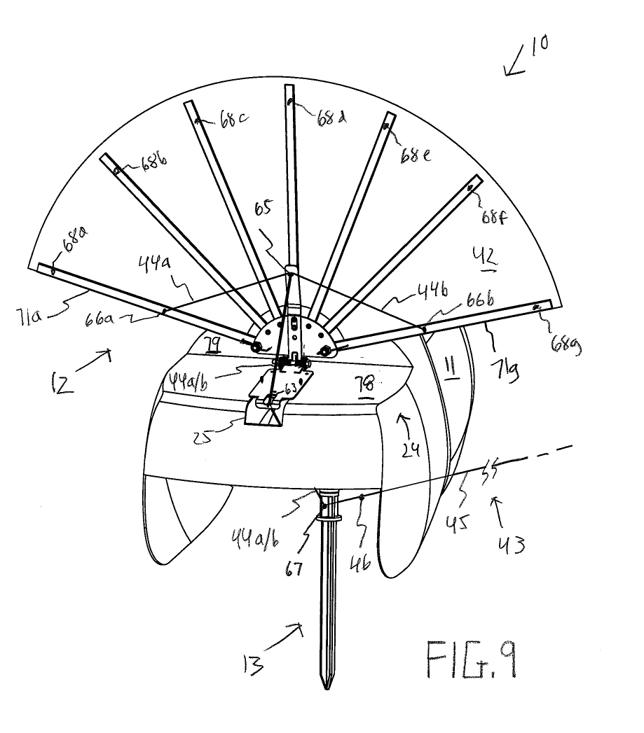

FIGS. 1-8, show a preferred embodiment of the decoy 10 of the present invention. The decoy 10 is intended to attract a certain species of animal, for example a wild turkey. The decoy 10 has both static and dynamic decoy features.

The decoy 10 includes primary elements of a decoy body 11, a fan assembly 12 connected to the decoy body 11, and a support assembly 13 connected to the decoy body 11 for contact with the environment. The decoy 10 is generally oriented with respect to a front 20, back 21, top 22 and bottom 23. A longitudinal aspect of the decoy 10 is aligned from front to back. A lateral aspect runs from side to side, perpendicular to the longitudinal aspect. The embodiment of the body 11 shown has a length of approximately 21 inches, a width of approximately 9 inches and a height of approximately 12 inches. These dimensions are with respect to the maximum measurable dimensions. The body 11 has a mounting area 24 on its back, top area for placement of the fan assembly 12. The mounting area 24 has a flat, horizontal bottom surface 78 which has are areas sufficient to mount elements of the fan assembly 12 and a substantially flat, vertical front side surface 79. Vertical surface 79 acts as a vertical backstop for the fan assembly 12. An actuator line aperture 25 is disposed in the bottom surface.

The embodiment of the decoy body 11 has a predetermined shape for mimicking the shape of an animal of interest, for example a wild turkey. In a most preferred embodiment, the wild turkey is a male or “tom” wild turkey. The body 11 is preferably constructed of a shell structure of a predetermined thickness and with predetermined outside dimensions and a generally hollow interior which is open at its bottom to minimize weight. The body 11 is preferably constructed of a lightweight, durable polymeric material. The body 11 exterior has a predetermined color and pattern arrangement also to mimic that of the animal of interest. Body, feather, and other features and patterns are preferably molded into the shell so that they are visible from the outside.

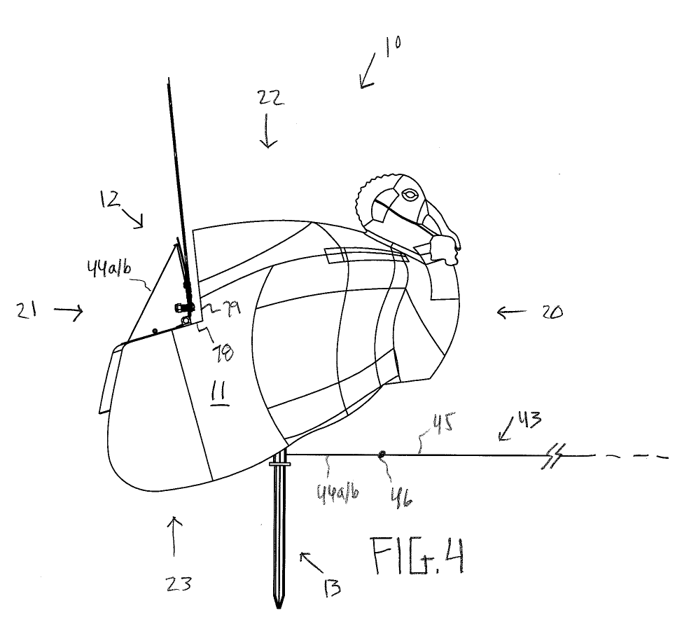

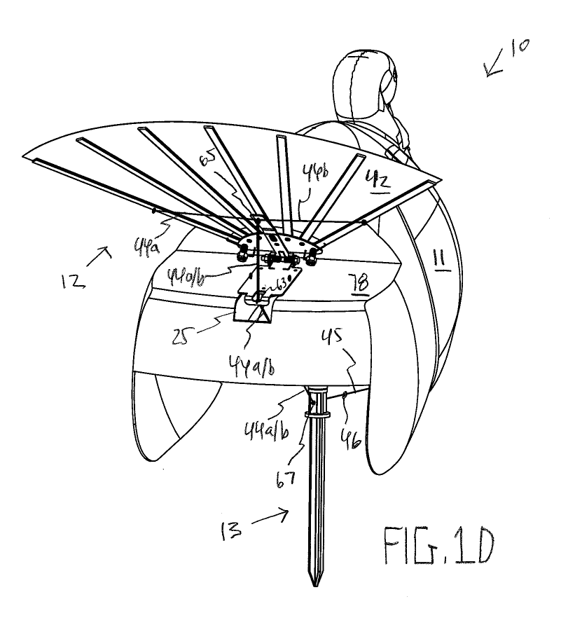

The fan assembly 12 is a dynamic, movable feature, in particular a fan tail of a male or “Tom” wild turkey, which is designed to create the illusion that the decoy 10 is alive and strutting. The fan assembly 12 embodiment preferably includes a bracket 40, a fan 41, a fan cover 42, and an actuator 43. The bracket 40 is connected to the body 11 at the mounting area 24. The fan 41 is connected to the bracket. The fan cover 42 is preferably a flexible structure or assembly that mimics the look and feel of a wing or appendage of the subject decoy species, for example the rear tail fan of a male (Tom) wild turkey. The cover 42 is preferably constructed of fabric which has a color pattern designed to simulate the rear tail fan of the turkey. The fabric is preferably a synthetic material, but may be a natural material or a blend of natural and synthetic materials. The fan cover 42 is coupled to the fan 41, preferably by covering it. Alternatively, it may be attached to one or both sides of the fan 41. In a still further alternative embodiment, the fan cover 42 may consist of individual natural feathers affixed to the fan 41 either mechanically (by sewing or connectors for example) or adhesively. In the preferred embodiment shown, the fan cover 42 has a, flat, thin, bag-type configuration with two fabric faces (one face 26a is shown in FIG. 3) surrounding a hollow interior. The top, curvilinear, outer edge 27 of each face is sewn together, as are the side, rectilinear outer edges 28. The bottom edge of each face 26 has a semi-circular approximately matching the configuration of the hub 70. The faces 26 are preferably coupled to the fan assembly via stitches 68 a-g as shown in FIG. 9.

The preferred embodiment of the actuator 43 is a flexible line having a predetermined length which is connected at one end to remaining elements of the fan assembly 12 and extends away from the decoy 10 to be held at its other end, or an intermediate position along the length of the line, by the user. The line is preferably string. The user actuates the fan assembly 12 by pulling on the line. In a preferred embodiment, the actuator line 43 includes a pair of proximal, first lines 44 a and b, and a distal second line 45. The first lines 44 a/b each (equally) have a predetermined, relatively short length of approximately 2 feet, and are disposed near the decoy 10 and as described in detail below. The lines 44 a and b are disposed side by side. The second line 45 has a predetermined, relatively long length, preferably approximately 100 feet, and is connected to the distal ends of the first lines 44 a/b by a connector 46. The connector 46 is preferably a swivel type connector. The second line 45 extends to the user. The distal portion of the second line 45 is preferably managed by wrapping around a line caddy 33.

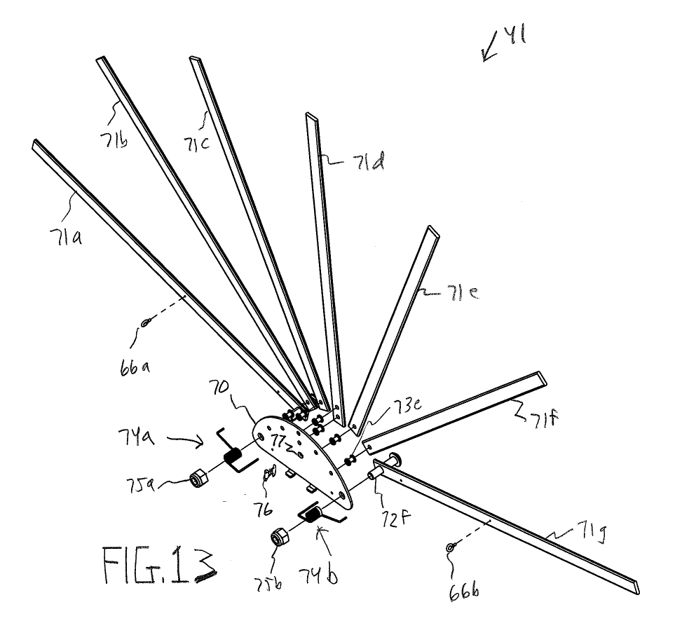

The Referring also to FIG. 12, the bracket 40 movably connects the fan 41 to the body 11. The embodiment of the bracket 40 shown is constructed and arranged of a base 50 and a tail member 51 which are movably connected by a spring actuator 52. The base 50 preferably includes a base body 55 with an forward actuator pivot portion 56 and a rearward back portion 57 The tail member 51 has a bottom pivot portion 58 for coupling with the base 55. A fan connection aperture 59 is disposed approximately in the middle of the tail 51 and a line guide 65 is disposed near its top end. The base body 55 is connected to the mounting surface 25, preferably by rivets. The base body 55 has a line aperture 63 and a line guide 64 through which actuator lines 44 a/b extend via aperture 25. The spring actuator 52 preferably includes a spring 60, a shaft 61 disposed through the central axis of the spring 60 and actuator portion 56, and a connector 62 (for example a bolt). Referring also to FIG. 9, the spring 60 biases the tail member 51 in a normally vertical, upright position with respect to the base 50.

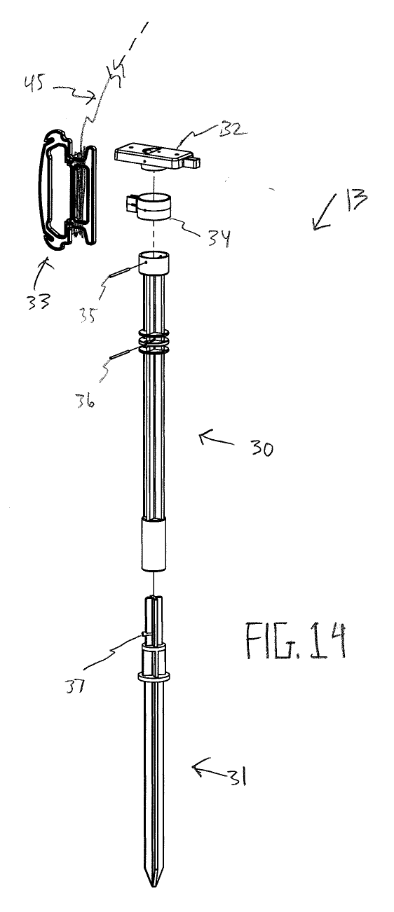

Referring also to FIG. 13, the fan 41 supports the fan cover with respect to the body 11, and in cooperation with the bracket 40 and actuator 43, under manual control of the user, realistically simulates the combination lateral (spreading and retraction) and longitudinal (raising and collapsing) motion of the rear tail fan of the turkey to mimic the strutting behavior of such turkey. The embodiment of the fan 41 shown is constructed and arranged of a hub 70, struts 71a-g, end strut shafts 72, interior strut shafts 73, springs 74 a and b, and connectors 75. The hub 70 is preferably removably connected to the bracket tail member 51 by way of a wing nut and bolt 76 or similar fastener which extends through a aperture 77 of the hub 70 and aperture 59 of bracket tail 51 The struts 71a-g are elongated semi-flexible members which have a length of approximately 12 inches, width of approximately 0.5 inches and a thickness of approximately ⅛^{th} inch. They are pivotally connected at their base of proximal end to the hub 70 via shafts (end struts 71 a and g via end shafts 72, and interior struts 71b-f via interior shafts 73. Springs 74 a and b are connected to the hub 70 and the end strut shafts 71a and 71g and normally bias the shafts 71 a and g laterally outwardly (spread), as shown also for example in FIG. 9. End struts 71 and 71 g have hook eye connectors 66 a and b for connection to the actuator 43 lines. The

Referring also to FIG. 14, the support assembly 13 holds the decoy 10 in a predetermined location specified by the user. The support assembly 13 is preferably a stake-type device that is inserted into the ground. However, it is within the purview of the invention that the support may be of another type for example a flat base device, including weighted or un-weighted, a wheeled device, or the like. The support assembly 13 embodiment shown includes a top support 30, a bottom stake 31, a slide connector 32, the line caddy 33, a line caddy bracket 34, a pin 35 therefor, and a connector pin 36. The connector 32 is connected to the interior of the body 11. The top support 30 is connected to the connector via bracket 34. In the embodiment shown, the bottom stake 31 is approximately 10 inches long and the top support is approximately 12 inches long such that it extends from the top of the interior of the body 11 to just outside the interior for ease of connection and disconnection with the stake 31. In use, the bottom stake 31 is inserted into earth at a decoy 10 deployment location selected by the user and then it is mated with the top support 30. The stake 31 has an alignment post 37 that mates with a complementary alignment slot (not shown) on the top support 30. Stake 31 also preferably has a line alignment aperture 67 disposed at its top end. The stake 31 is connectable and disconnectible for easy deployment, collapsing, transportation and storage.

The function of the decoy 10 following deployment by way of the stake or other placement or support is best shown with reference to FIGS. 9-11. The decoy is shown in its normal or default arrangement in FIG. 9 In this configuration, the fan assembly 12 is in a fully upright (vertically) and fully spread (laterally). As discussed above. The fan assembly is biased in this position by cooperating forces provided by springs 60 and 74 a/b. The actuator 43 lines 44 a and b are attached at their proximal ends to connectors 66 a and g, respectively, on the fan 41 struts 71a and g. The lines 44 a and b run separately to line guide 65 on bracket 40. From this point, the lines 44 a/b run along side each other to line guide 64, through corresponding apertures 63 and 25, and down through line alignment aperture 67 in stake 31. In this embodiment, the distal end of both lines 44 a and 44b are connected to swivel connector 46, which is joined to distal line 45.

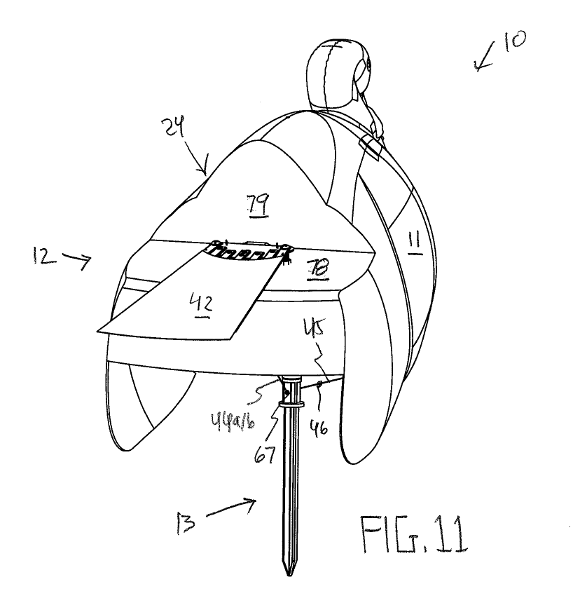

FIG. 10 shows the fan assembly 12 at its approximately 50 percent actuated state, being pulled downwardly along the longitudinal aspect of the decoy 10 and retracted laterally, by the user pulling on the actuator 43. The line 43 pulls equally on each line 44 a/b through guides 67, 63 and 65. This pulls outside struts 71 a and g pivotally towards each other. As the outside struts 71 a and g come together the cover 42 pulls the interior struts 71 b-f together via the stitch 68 or other attachments.

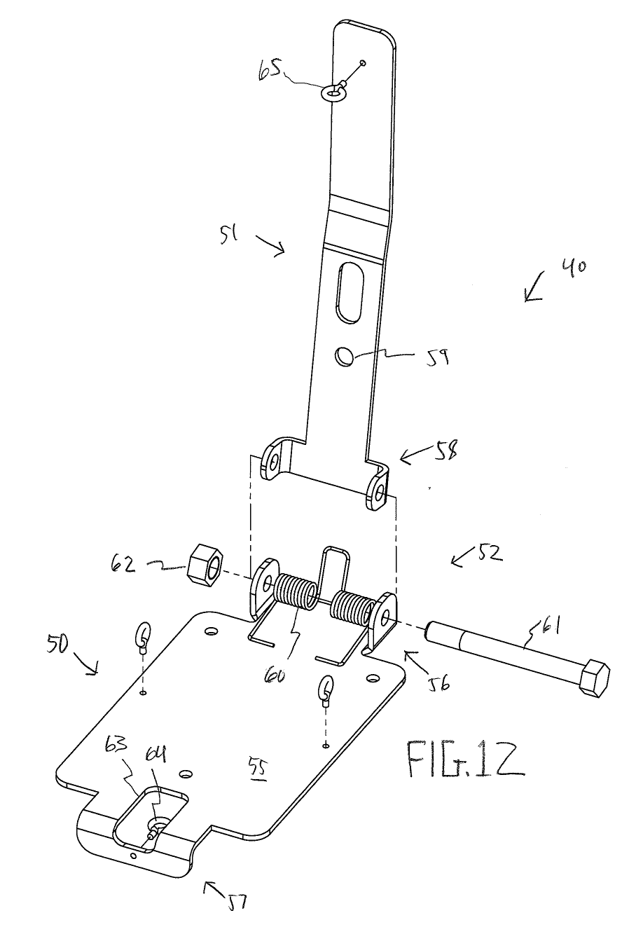

FIG. 11 shows the fan assembly 12 at its approximately fully actuated state, by continued pulling the actuator 43 lines by the user. In this arrangement, the fan 12 is substantially horizontal and pointing backwards relative to the body 11, and it is laterally retracted. Upon release of the actuator 43, the fan assembly 12 will automatically resume its normal configuration (FIG. 9) or an intermediary position (as shown for example in FIG. 10). The fan assembly 12 may be cyclically actuated many times. Actuation is fast and smooth, simulating the behavior of an actual tom turkey.

In summary, the invention provides a realistic, collapsible full-body, full strut jake decoy with a removable fan. It includes a string-activated mechanical tail that changes from the full strut open position to a fully closed down position by simply pulling the string. In use, the jake body and tail provoke aggressive mature tom turkeys to come in and challenge the decoy, providing the user with an optimum shot with either a firearm or bow and arrow.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. A decoy apparatus comprising a decoy body, a fan assembly attached to the decoy body, the fan assembly including a longitudinally pivotable bracket and a laterally pivotable fan attached to the bracket; and means to actuate the fan assembly so that the bracket longitudinally pivots and the fan laterally pivots.

2. The decoy apparatus of claim 1, wherein the decoy body has a hollow interior.

3. The decoy apparatus of claim 1, wherein the decoy body has a mounting area for mounting the bracket.

4. The decoy apparatus of claim 3, wherein the mounting area has a flat horizontal portion and a flat vertical portion.

5. The decoy apparatus of claim 1, wherein the bracket includes a base, a tail pivotally connected to the base, and a spring connected to the base and the tail that biases the tail with respect to the base.

6. The decoy apparatus of claim 5, wherein the base is connected to the body.

7. The decoy apparatus of claim 5, wherein the fan is connected to the tail.

8. The decoy apparatus of claim 5, wherein the spring biases the tail normally away from the base.

9. The decoy apparatus of claim 1, wherein the fan includes a hub, a plurality of elongated struts pivotally connected to the hub, a flexible decoy member connected to at least one strut, and at least one spring connected to the hub and at least one strut that biases at least one strut with respect to the remaining struts.

10. The decoy apparatus of claim 9, wherein the hub is connected to the bracket.

11. The decoy apparatus of claim 9, wherein there are at least three struts, two being at ends in an array, and at least one in the middle of the array.

12. The decoy apparatus of claim 11, wherein there are seven struts.

13. The decoy apparatus of claim 9, wherein the flexible decoy member is a bag-style fabric member disposed over the struts and secured to at least one strut.

14. The decoy apparatus of claim 9, wherein the at least one fan spring biases the struts normally away from each other.

15. The decoy apparatus of claim 1, wherein the means to actuate includes at least one line communicatively connected to the bracket and connected to the fan, the line extending away from the body and being adapted to be pulled by a user of the decoy apparatus to longitudinally pivot the bracket and laterally pivot the fan.

16. The decoy apparatus of claim 15, wherein the line has a proximal end which is connected to at least one strut, and the line extends distally away from the strut and is slidably communicatively connected to at least two points on the bracket.

17. The decoy apparatus of claim 15, wherein there are two lines, each line being connected to separate struts.

18. The decoy apparatus of claim 1, further comprising a support assembly connected to the body for securing the body to the environment.

19. A decoy apparatus comprising:
a. a decoy body;
b. a fan assembly attached to the decoy body, the fan assembly including a longitudinally pivotable bracket and a laterally pivotable fan attached to the bracket, wherein the bracket includes a base, a tail pivotally connected to the base, and a spring connected to the base and the tail that biases the tail with respect to the base, and wherein the fan includes a hub, a plurality of elongated struts pivotally connected to the hub, a flexible decoy member connected to at least one strut, and at least one spring connected to the hub and at least one strut that biases at least one strut with respect to the remaining struts;
c. means to actuate the fan assembly so that the bracket longitudinally pivots and the fan laterally pivots, wherein the means to actuate includes at least one line communicatively connected to the bracket and connected to the fan, the line extending away from the body and being adapted to be pulled by a user of the decoy apparatus to longitudinally pivot the bracket and laterally pivot the fan; and
d. a support assembly connected to the body for securing the body to the environment

20. A portable, wild turkey decoy apparatus, comprising:
a. a decoy body;
b. a fan assembly attached to the decoy body, the fan assembly including
(i) a longitudinally pivotable bracket and
(ii) a laterally pivotable fan attached to the bracket,
wherein the bracket includes a base, a tail pivotally connected to the base, and a spring connected to the base and the tail that biases the tail with respect to the base, the spring normally biasing the tail away from the base, and
wherein the fan includes a hub, a plurality of elongated struts pivotally connected to the hub, a flexible bag-style decoy member covering the struts and connected to at least one strut, and at least one spring connected to the hub and at least one strut that biases at least one strut with respect to the remaining struts, the spring normally biasing the struts away from one another;
c. at least one line communicatively connected to the bracket and connected to the fan, the line actuating the fan assembly so that the bracket longitudinally pivots and the fan laterally pivots, the line extending away from the body and being adapted to be pulled by a user of the decoy apparatus to longitudinally pivot the bracket and laterally pivot the fan; and
d. a support assembly connected to the body for securing the body to the environment
